(19) United States
(12) Patent Application Publication
(10) Pub. No.: US 2009/0166395 A1
(43) Pub. Date: Jul. 2, 2009

(54) METHOD OF JOINING METAL MATERIAL

(75) Inventors: Kazuhiro Nakata, Osaka (JP); Hidetoshi Fujii, Osaka (JP); Takeshi Ishikawa, Kanagawa (JP); Walter Veldsman, Surrey (GB); Andrew Johnson, Calgary (CA)

Correspondence Address: OSHA LIANG L.L.P., TWO HOUSTON CENTER, 909 FANNIN, SUITE 3500, HOUSTON, TX, 77010, US

(73) Assignees: OSAKA UNIVERSITY, Suita-shi, Osaka (JP); TOKYU CAR CORPORATION, Yokohama-Shi, Kanagawa (JP)

(21) Appl. No.: 12/282,509

(22) PCT Filed: Mar. 7, 2007
(86) PCT No.: PCT/JP2007/054469

§ 371 Date: Dec. 23, 2008

(30) Foreign Application Priority Data
Mar. 10, 2006 (JP) 2006-066510

(51) Int. Cl. B23K 20/12

(52) U.S. Cl. 228/112.1

(57) ABSTRACT

Metal materials made of iron (Fe) or the like are butted together at a joint, and a probe of a rotary tool is inserted into the joint. The rotary tool is rotated while being moved in the lengthwise direction of the joint, whereby the metallographic structure of the joint is stirred, and the metal materials are joined. While the rotary tool is being rotated and moved, liquid CO₂ is supplied to the joint and the rotary tool. Electromagnetic valves are suitably opened and closed so that nozzles discharge the liquid CO₂ from the rear in the movement direction of the rotary tool. Supplying the liquid CO₂ to the joint and the rotary tool reduces wear of the rotary tool, and also increases the joining strength of the joint.

### TECHNICAL FIELD

The present invention relates to a method for joining metal materials.

### BACKGROUND ART

With a conventional method for joining metal materials, a known technique is to join the metal materials by friction stir welding (FSW). In friction stir welding, the metal materials to be joined are disposed opposite each other at the joint, a probe provided to the distal end of a rotary tool is inserted into the joint, and the rotary tool is rotated to join the two metal materials. Good joint strength can be obtained with friction stir welding, so its use has been proposed even when joining iron and other such metals of high hardness (see, for example, Japanese Laid-Open Patent Application 2002-273579).

Patent Document 1: Japanese Laid-Open Patent Application 2002-273579

### DISCLOSURE OF THE INVENTION

### Problem to be Solved by the Invention

However, when an attempt is made to join iron and other such metal materials of high hardness by friction stir welding as in Japanese Laid-Open Patent Application 2002-273579, a drawback is excessive wear to the rotary tool, which means that the rotary tool has a shorter service life.

The present invention was conceived in light of this situation, and it is an object thereof to provide a method for joining metal materials with which wear of the rotary tool can be reduced even when joining hard metal materials by friction stir welding.

### Means for Solving the Problem

The present invention is a method for joining metal materials, wherein two metal materials, at least one of which comprises a metal or an alloy thereof having a melting point of at least 1000° C. are disposed opposite each other at a joint, a rod-shaped rotary tool is inserted into the joint, a cooled coolant is supplied to either the joint or the rotary tool, and the rotary tool is rotated, whereby the two metal materials are joined.

When an aluminum alloy is being joined, the temperature in the stirred zone is approximately 450° C., and the rotary tool is made from tool steel such as SKD 61 steel as specified by JIS. When an iron or steel material is being joined, however, the temperature in the stirred zone may reach approximately 1200° C., so the rotary tool is subjected to a greater temperature load, and the service life of the rotary tool will be shorter than when an aluminum alloy is joined. With a conventional joining apparatus such as that discussed in the above-mentioned Patent Document 1, the joint is sometimes cooled with water, oil, an inert gas, or the like in order to reduce residual stress and deformation at the joint. However, supplying a cooled coolant such as liquid CO₂ to the joint or the rotary tool was not done in the past out of fear that the lower temperature would make friction stir welding impossible. Diligent research on the part of the inventors, however, has revealed that when hard metal materials are joined by friction stir welding, wear to the rotary tool can be reduced by supplying a cooled coolant to either the joint or the rotary tool. With this constitution, even when hard metal materials comprising a metal and/or an alloy having a melting point of at least 1000° C. are joined by friction stir welding, there will be less wear to the rotary tool because a cooled coolant is supplied to the joint or the rotary tool.

In addition, with friction stir welding, a reduction in crystal grain size due to dynamic recrystallization is seen in the stirred zone, but the crystal grains are made coarser by frictional heat in the heat affected zone on the outside of the stirred zone, and this diminishes joint strength. Nevertheless, the production of coarser crystals in the heat affected zone can be prevented, and a stronger joint is obtained, by supplying a cooled coolant to the joint or the rotary tool.

The method of the present invention for joining metal materials encompasses two scenarios: when the rotary tool is rotated while it is moved in the lengthwise direction of the joint, and when the rotary tool that has been rotated at the joint is not moved, and instead continues to rotate at the same place. The term “friction stir welding” as used in this Specification refers to the following four modes (1) to (4), and to combinations of these: (1) friction stir welding in which the ends of metal sheets are butted together to make a joint, and the metal materials are joined together by rotating the rotary tool while moving it in the lengthwise direction of this joint, (2) spot friction stir welding (spot FSW) in which the ends of metal sheets are butted together to make a joint, and the metal materials are joined by rotating the rotary tool without moving it at the joint, (3) spot friction stir welding in which metal materials are laid over one the other at a joint, a hole is made that passes through at least one of the metal materials, a rotary tool is inserted into the joint, and the metal materials are joined by rotating the rotary tool at that place without moving it, and (4) friction stir welding in which metal materials are laid over one the other at a joint, a hole is made that passes through at least one of the metal materials, a rotary tool is inserted into the joint, and the metal materials are joined by rotating the rotary tool while moving it in the lengthwise direction of the joint.

In this case, two metal materials can be joined by rotating and moving the rotary tool in the lengthwise direction of the joint. With this constitution, since the two metal materials are joined by rotating the rotary tool while moving it in the lengthwise direction of the joint, the two metal materials can be joined even when the joint between the two metal materials is long.

In this case, a coolant is preferably supplied in a state that includes a portion in either the solid phase or the liquid phase. With this constitution, cooling is promoted by latent heat in the transition of the coolant from either the solid phase or the liquid phase to the vapor phase, so the joint or the rotary tool can be cooled more efficiently, and wear to the rotary tool can be reduced even more.

In this case, the coolant is preferably supplied after being cooled to a temperature of 0° C. or lower. With this constitution, since the coolant is supplied after being cooled to a temperature of 0° C. or lower, the joint or the rotary tool can be cooled even better, and wear to the rotary tool can be reduced even more.

In this case, the coolant is preferably liquid CO₂. With this constitution, since liquid CO₂ is used for the coolant, under normal pressure it will become CO₂ in the vapor phase and CO₂ in the solid phase. The solid phase CO₂ does not produce a vapor phase layer at the interface when it comes into contact with the joint, etc., so the joint or the rotary tool can be cooled even better, and wear to the rotary tool can be reduced even more.

### EFFECT OF THE INVENTION

With the method of the present invention for joining metal materials, wear to the rotary tool can be reduced even when joining hard metal materials by friction stir welding.

### BRIEF DESCRIPTION OF THE DRAWINGS

FIG. 1 is an oblique view of the method for joining metal materials pertaining to a first embodiment of the present invention;

FIG. 2 is an oblique view of the method for joining metal materials pertaining to a second embodiment of the present invention;

FIG. 3 is a graph of the wear to the rotary tool pertaining to a first test example of the present invention;

FIG. 4 is a graph of the wear to the rotary tool pertaining to a second test example of the present invention;

FIG. 5 is a graph of the joint distance in a third test example of the present invention;

FIG. 6 shows the metallographic structure of the upper part of the joint when liquid CO₂ was not supplied in the third test example of the present invention;

FIG. 7 shows the metallographic structure of the middle part of the joint when liquid CO₂ was not supplied in the third test example of the present invention;

FIG. 8 shows the metallographic structure of the lower part of the joint when liquid CO₂ was not supplied in the third test example of the present invention;

FIG. 9 shows the metallographic structure of the upper part of the joint when liquid CO₂ was supplied in the third test example of the present invention;

FIG. 10 shows the metallographic structure of the middle part of the joint when liquid CO₂ was supplied in the third test example of the present invention;

FIG. 11 shows the metallographic structure of the lower part of the joint when liquid CO₂ was supplied in the third test example of the present invention; and

FIG. 12 is a graph of the tensile strength of the joint in the third test example of the present invention.

### EXPLANATION OF THE REFERENCE NUMERALS

10 joining apparatus
11 rotary tool
12 probe
14 shoulder
16, 18 nozzle
20, 22 electromagnetic valve
24, 26 hose
28 hose
30 first safety valve
32 ball valve
34 second safety valve
36 hose
38 liquid CO₂ tank
40 liquid CO₂
42 manual valve
44 rupture plate
100, 102 metal material
104 joint
106 insertion hole
108 joined part

### BEST MODE FOR CARRYING OUT THE INVENTION

Embodiments of the present invention will now be described through reference to the appended drawings. Those constituent elements that are the same are numbered the same, and redundant descriptions will be omitted.

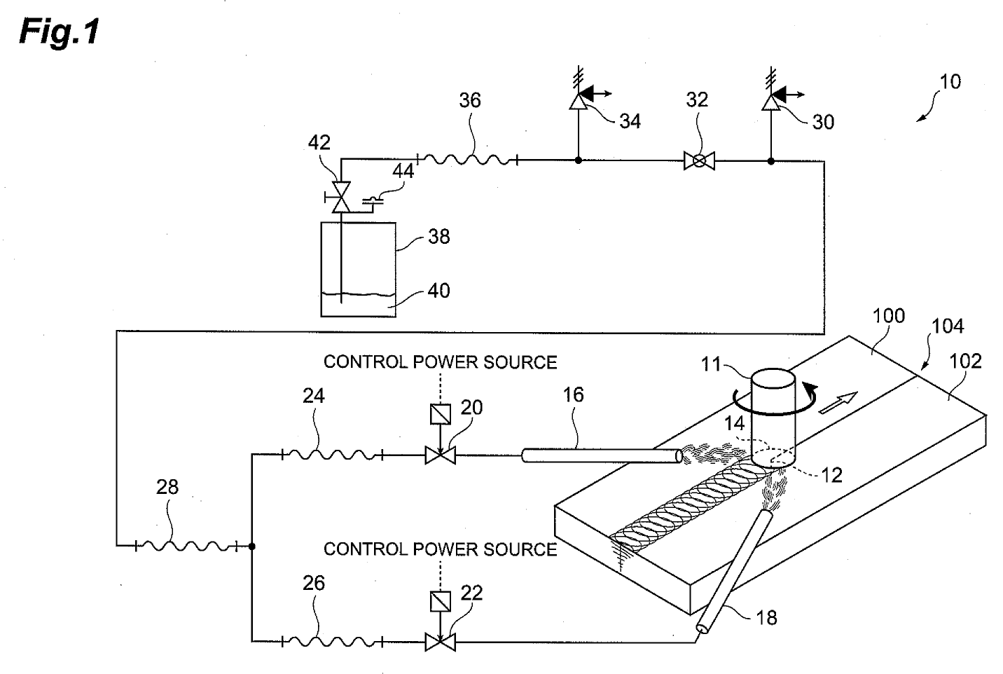

FIG. 1 is an oblique view of the method for joining metal materials pertaining to a first embodiment of the present invention. The joining apparatus 10 in this embodiment is constituted such that two metal materials 100 and 102, at least one of which is composed of copper, a copper alloy, or another such metal or alloy of a metal having a melting point of at least 1000° C., and preferably iron, chromium, cobalt, tungsten, nickel, molybdenum, titanium, stainless steel, carbon steel, or another such metal having a melting point of at least 1200° C., and preferably both of which are composed of these metals, are joined at a joint 104 by friction stir welding.

As shown in FIG. 1, the joining apparatus 10 of this embodiment comprises a rod-shaped rotary tool 11. The rotary tool 11 comprises at its distal end a probe 12 that is inserted into the joint 104 of the metal materials 100 and 102 and a shoulder 14. The probe 12 is in the form of a substantially circular cylinder that is smaller in diameter than the shoulder 14. The rotary tool 11 is used to join the metal materials 100 and 102 together by stirring the metal at the joint 104 by inserting the probe 12 into the joint 104 and rotating it while moving it in the lengthwise direction of the joint 104. In this embodiment, the material of which the rotary tool 11 is made is, for example, tool steel such as SKD 61 steel as specified by JIS, or a cemented carbide such as tungsten carbide (WC) and cobalt (Co), or a ceramic such as Si₃N₄.

The joining apparatus 10 is equipped with two nozzles 16 and 18. The nozzles 16 and 18 are used to supply liquid CO₂ as a coolant to the joint 104 and the rotary tool 11. In addition to liquid CO₂, liquid N₂ or the like can also be used as the coolant, for example, but when liquid N₂ is supplied as the coolant, a layer of gas will be produced at the surface of the joint 104 or the rotary tool 11, decreasing the cooling efficiency, so liquid CO₂ is preferable as the coolant.

In this embodiment, the nozzles 16 and 18 supply the liquid CO₂ from the rear in the movement direction of the rotary tool 11, but the supply direction of the liquid CO₂ is not limited to this. Also, the liquid CO₂ may be supplied from the opposite side of the metal materials 100 and 102 from the side on which the rotary tool 11 is inserted, but the liquid CO₂ is preferably supplied from the side of the metal materials 100 and 102 on which the rotary tool 11 is inserted. Furthermore, besides a method in which the liquid CO₂ is supplied from the nozzles 16 and 18, it is also possible to supply the liquid CO₂ to the joint 104 and the rotary tool 11 by a method in which the liquid CO₂ is discharged from a discharge hole that goes from inside the rotary tool 11 to the distal end of either the probe 12 or the shoulder 14. Alternatively, the liquid CO₂ can also be supplied to the joint 104 and the rotary tool 11 by surrounding the rotary tool 11 with a cylindrical member, and allowing the liquid CO₂ to flow into this cylindrical member. Electromagnetic valves 20 and 22 are connected to the nozzles 16 and 18, respectively. The electromagnetic valves 20 and 22 are used to suitably open and close the channel of the liquid CO₂ discharged from the nozzles 16 and 18 according to control signals supplied from a control power source. The joining apparatus 10 is equipped with flexible hoses 24 and 26 for supplying liquid CO₂ to the nozzles 16 and 18, respectively. The hoses 24 and 26 are both connected to a single flexible hose 28, and the hose 28 supplies liquid CO₂ to the hoses 24 and 26. The amount in which the liquid CO₂ is supplied is, for example, from 1.0 to 2.0 kg/min, the supply pressure is from 1.5 to 3.0 MPa, and the temperature is from 70° C. to −20° C.

The joining apparatus 10 comprises a first safety valve 30, a ball valve 32, and a second safety valve 34 between a hose 36 and the hose 28 that supplies the liquid CO₂. The ball valve 32 has a valve body that is a spherical slide valve, and opens and closes the liquid CO₂ supply path. The first safety valve 30 and the second safety valve 34 ensure safe operation by allowing internal gas to escape to the outside when the internal pressure of the liquid CO₂ supply path rises over a specific level. The joining apparatus 10 comprises a liquid CO₂ tank 38 connected to the hose 36. The inside of the liquid CO₂ tank 38 is kept at a specific temperature and pressure, and liquid CO₂ 40 is sealed inside. The liquid CO₂ tank 38 comprises a manual valve 42 for opening or closing the tank. The liquid CO₂ tank 38 is equipped with a rupture plate 44. The rupture plate 44 ensures safe operation by allowing internal gas to escape to the outside when the internal pressure of the liquid CO₂ tank 38 rises over a specific level.

The effect of the method for joining metal materials of this embodiment will now be described. In the joining of the metal materials 100 and 102, the metal materials 100 and 102 are butted together at the joint 104, and the probe 12 of the rotary tool 11 is inserted into the joint 104. The rotary tool 11 is rotated while being moved in the lengthwise direction of the joint 104, which stirs the metallographic structure of the joint 104, joining the metal materials 100 and 102 together. The metal materials 100 and 102 can also be joined by spot friction stir welding in which the rotary tool 11 is not moved, and is instead rotated in place at the joint 104.

In this embodiment, the electromagnetic valves 20 and 22 are suitably opened and closed to supply liquid CO₂ to the joint 104 and the rotary tool 11 when the rotary tool 11 is rotated and moved. The nozzles 16 and 18 discharge liquid CO₂ from the rear in the movement direction of the rotary tool 11.

The temperature in the stirred zone during the joining of an aluminum alloy is approximately 450° C., and the rotary tool is generally made from tool steel such as SKD 61, which is regulated under JIS. When an iron or steel material is being joined, however, the temperature in the stirred zone may reach 1200° C., so the rotary tool is subjected to a greater temperature load, and the service life of the rotary tool will be shorter than when an aluminum alloy is joined. With a conventional joining apparatus such as that discussed in the above-mentioned Patent Document 1, the joint is sometimes cooled with water, oil, an inert gas, or the like in order to reduce residual stress and deformation at the joint. However, supplying a cooled coolant such as liquid CO₂ to the joint was not done in the past out of fear that the lower temperature would make friction stir welding impossible. As a result of diligent research on the part of the inventors, however, it is believed that even when a cooled coolant such as liquid CO₂ is supplied to the joint or the rotary tool, there is no great fluctuation in the critical speed, which is the maximum joining speed at which joining is possible, and the maximum attainable temperature does not change at the joint. It was revealed that when hard metal materials are joined by friction stir welding, wear to the rotary tool can be reduced by supplying a cooled coolant to either the joint or the rotary tool. Although it is not clear why wear to the rotary tool is reduced by supplying a cooled coolant, it is believed that supplying a cooled coolant to the outer surface of the joint and the rotary tool at least partially cools the tool, and has the effect of reducing wear to the rotary tool.

Also, diligent research on the part of the inventors has revealed that when hard metal materials are joined by friction stir welding, the strength of the joint can be increased by supplying a cooled coolant to either the joint or the rotary tool. With friction stir welding, a reduction in crystal grain size due to dynamic recrystallization is seen in the stirred zone, but the crystal grains are made coarser by frictional heat in the heat affected zone on the outside of the stirred zone, and this diminishes joint strength. Nevertheless, the production of coarser crystals in the heat affected zone can be prevented, and a stronger joint obtained, by supplying a cooled coolant to the joint or the rotary tool.

Furthermore, in this embodiment, liquid CO₂ is supplied to the joint 104 and the rotary tool 11. When discharged from the nozzles 16 and 18, under normal pressure, the liquid CO₂ transitions to the vapor phase and the solid phase. CO₂ that has adhered to the joint 104 and the rotary tool 11 in the solid phase does not produce a gas layer at the interface between the joint 104 and the rotary tool 11, so the joint 104 and the rotary tool 11 can be cooled more efficiently. In addition, when liquid CO₂ is supplied and SS 400 or another such carbon steel specified by JIS is joined, the metallographic structure is morphologically controlled to a structure composed of martensite, which is high in hardness, and ferrite, which is low in hardness but is sticky, so the hardness of the stirred zone is increased and the joint strength is higher compared to a structure composed of ferrite and perlite which has low hardness when liquid CO₂ is not supplied.

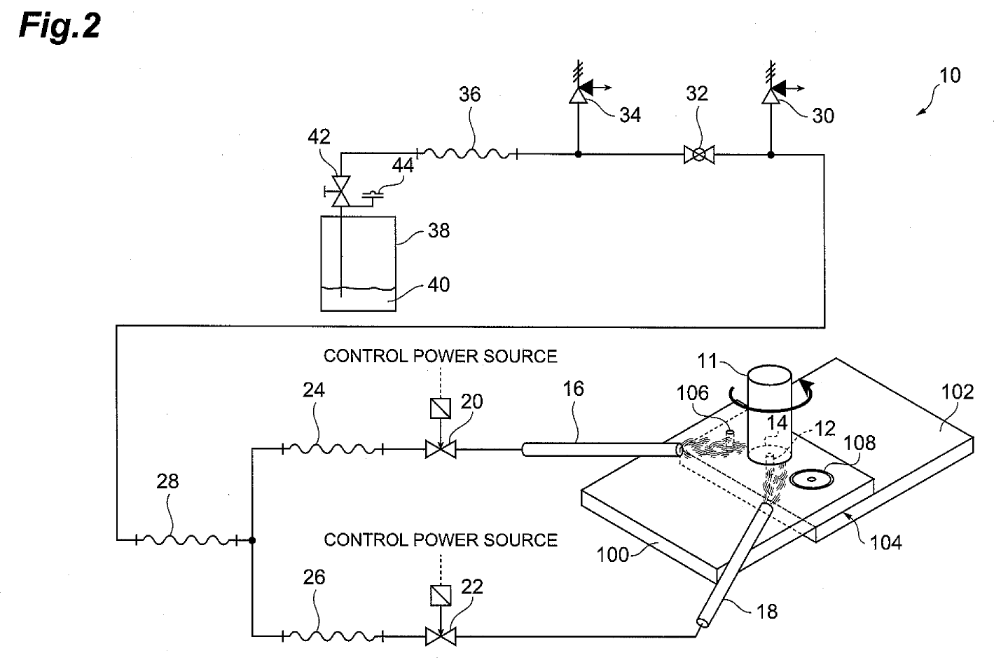

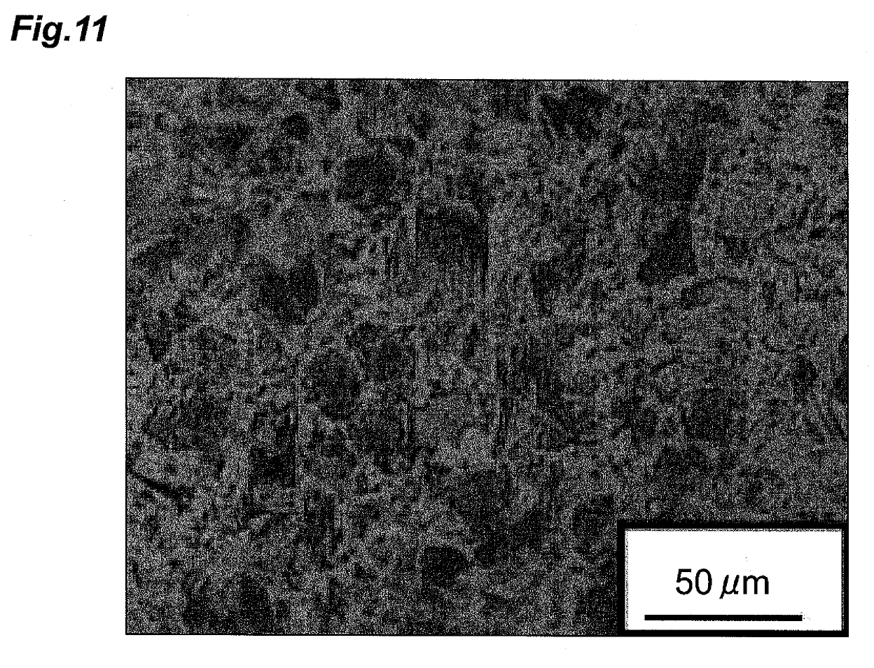

A second embodiment of the present invention will now be described. FIG. 2 is an oblique view of the method for joining metal materials pertaining to the second embodiment of the present invention. This embodiment differs from the first embodiment in that spot friction stir welding is performed in which one of the metal materials 100 and 102 is laid over the other, and the materials are joined without moving the rotary tool 11. As shown in FIG. 2, in this embodiment the metal materials 100 and 102 are overlapped at the joint 104, and an insertion hole 106 is made that passes through at least the metal material 100. Next, the probe 12 of the rotary tool 11 is inserted through the insertion hole 106 into the joint 104 and is rotated in place, without being moved, to join the metal materials 100 and 102. After joining, the finished joint 108 shown in FIG. 11 is formed. In this embodiment, the overlapping metal materials 100 and 102 can be joined. Further, the overlapping metal materials 100 and 102 can be joined by friction stir welding in which the metal materials 100 and 102 are joined by rotating the rotary tool 11 inserted into the joint 104 while moving this tool in the lengthwise direction of the joint 106.

The inventors conducted experiments in which metal materials were actually joined by the method of the present invention for joining metal materials, the results of which will now be described in comparison to a conventional method.

### Test Example 1

Two sheets of SUS 304, which is a stainless steel material specified by JIS, with a thickness of 1.5 mm were joined by friction stir welding while liquid CO₂ was supplied to the rotary tool and the joint, as shown in FIG. 1. The rotary tool had a probe diameter of 5.00 mm and a shoulder diameter of 15 mm and was composed of Si₃N₄, and the friction stir welding was conducted at a rotary speed of 600 rpm, a movement speed of 420 mm/min, and under a load^{[3] of} 1600 kgf to the rotary tool. Also, for the sake of comparison, SUS 304 materials were joined under the same conditions except that no liquid CO₂ was supplied. The distance joined at one time was 300 mm, and friction stir welding was repeated as many times as possible at a joining distance of 300 mm each time.

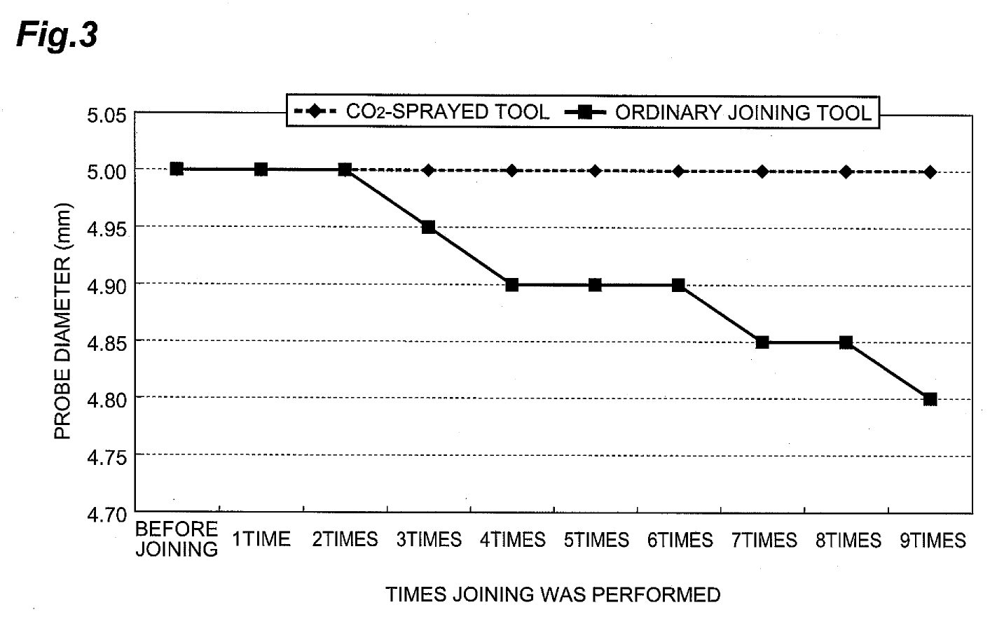

FIG. 3 is a graph of the wear to the rotary tool pertaining to the first test example of the present invention. As shown in FIG. 3, when friction stir welding was performed while liquid CO₂ was supplied, no wear to the probe of the rotary tool could be measured after joining nine times. Nor did the probe break even after joining 10 m. On the other hand, when liquid CO₂ was not supplied and function stir welding was performed, the probe diameter of the rotary tool after joining nine times had decreased by wear from 5.00 mm to 4.50 mm, and the probe broke after joining the tenth time. The total joining distance until the probe broke was 3 m.

### Test Example 2

Two sheets of SUS 301-DLT, which is a stainless steel material specified by JIS, with a thickness of 1.5 mm were joined by friction stir welding while liquid CO₂ was supplied to the rotary tool and the joint, as shown in FIG. 1. The rotary tool had a probe diameter of 5.00 mm and a shoulder diameter of 15 mm and was composed of Si₃N₄, and the friction stir welding was conducted at a rotary speed of 600 rpm, a movement speed of 180 mm/min, and under a load 2ⱼ of 1600 kgf to the rotary tool. Also, for the sake of comparison, SUS 301-DLT materials were joined under the same conditions except that no liquid CO₂ was supplied. The distance joined at one time was 300 mm, and friction stir welding was repeated as many times as possible at a joining distance of 300 mm each time.

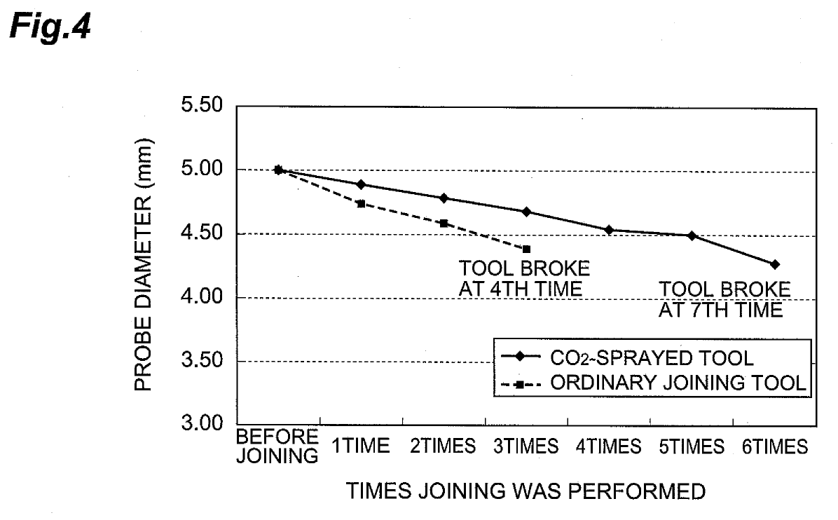

FIG. 4 is a graph of the wear to the rotary tool pertaining to the second test example of the present invention. As shown in FIG. 4, when friction stir welding was performed while liquid CO₂ is supplied, the probe of the rotary tool broke and further joining was impossible after joining seven times. On the other hand, when liquid CO₂ was not supplied and friction stir welding was performed, the probe broke and further joining was impossible after joining just four times. In this test example, SUS 301-DLT, which is less suitable to friction stir welding because its strength is higher at a higher temperature than in the first test example given above, was subjected to friction stir welding under harsher conditions than in the first test example above, but the service life of the rotary tool was longer when the friction stir welding was performed while liquid CO₂ was supplied.

### Test Example 3

Two sheets of SS 400, which is a carbon steel material specified by JIS, with a thickness of 3.2 mm were joined by friction stir welding while liquid CO₂ was supplied to the rotary tool and the joint, as shown in FIG. 1. The rotary tool had a probe diameter of 6.00 mm and was composed of WC and cobalt, and the friction stir welding was conducted at a rotary speed of 400 rpm, a movement speed of 150 mm/min, and under a load^{[2]} of 2400 kgf to the rotary tool. Also, for the sake of comparison, SS 400 materials were joined under the same conditions except that no liquid CO₂ was supplied. The distance joined at one time was 300 mm, and friction stir welding was repeated as many times as possible at a joining distance of 300 mm each time.

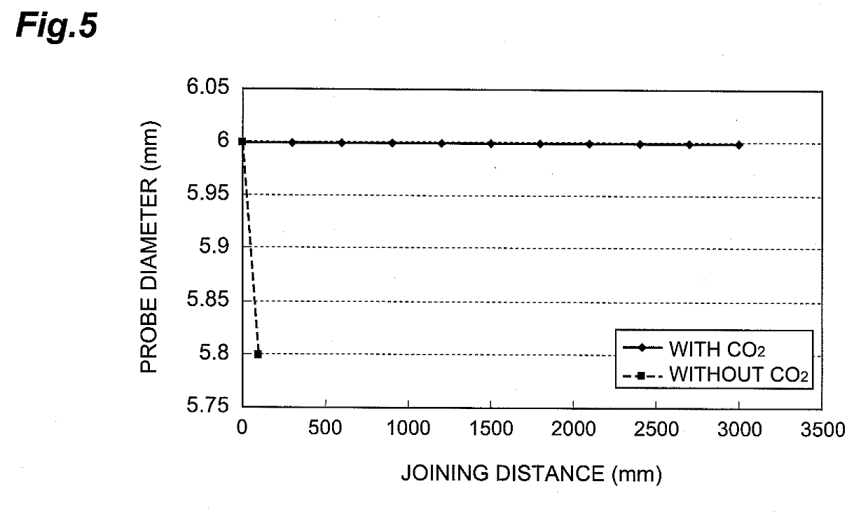

FIG. 5 is a graph of the joint distance in the third test example of the present invention. As shown in FIG. 5, when friction stir welding was performed while liquid CO₂ was supplied, no wear to the probe of the rotary tool could be measured even after joining for a distance of 3000 mm, and joining was still possible after that. On the other hand, when liquid CO₂ was not supplied and friction stir welding was performed, the probe diameter after joining for a distance of 100 mm had decreased by wear from 6.00 mm to 5.80 mm, and the probe broke.

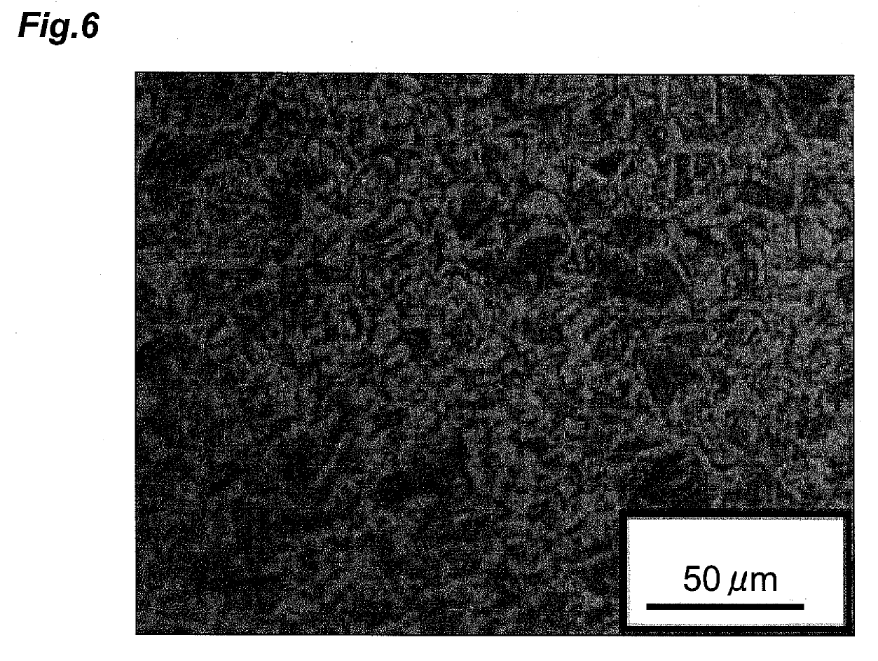

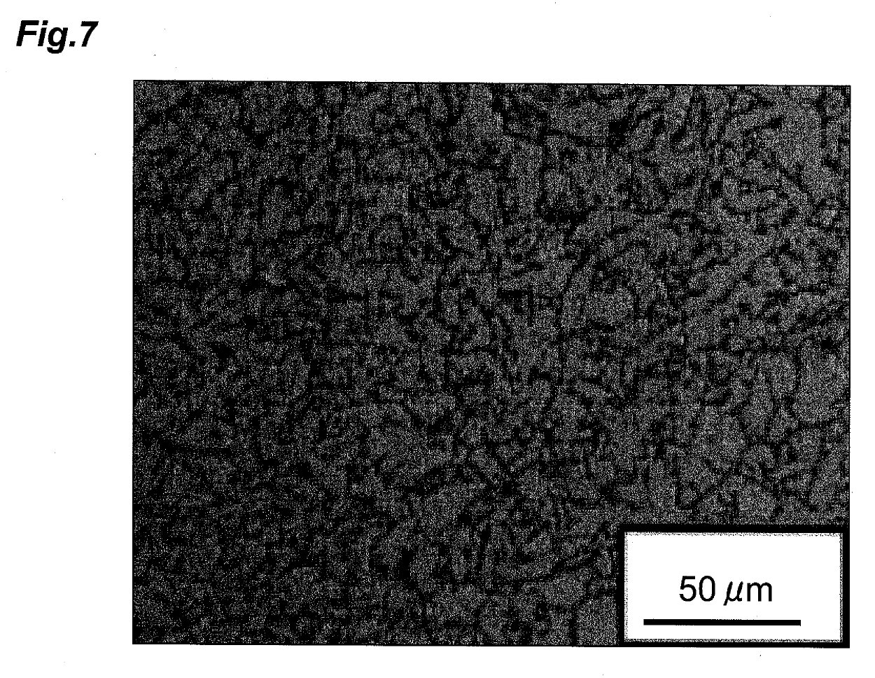

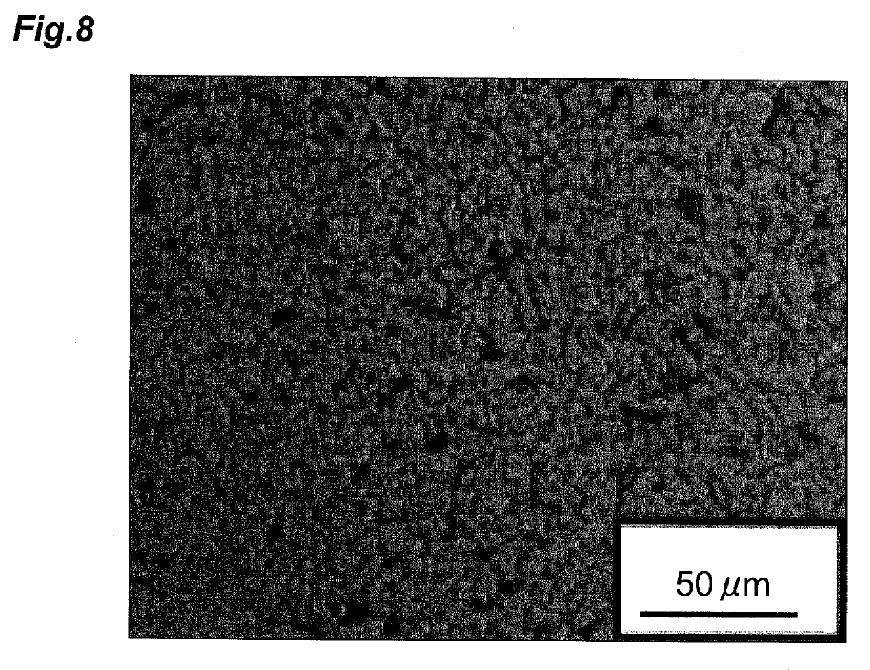

FIGS. 6 to 8 show the metallographic structure of the metal materials at the upper part, middle part, and lower part, respectively, of the joint when friction stir welding was performed without supplying liquid CO₂. As shown in FIG. 6, when friction stir welding was performed without supplying liquid CO₂, the metallographic structure of the SS 400 material at the upper part of the joint comprised martensite, which is harder and appears black, and ferrite, which is softer and appears white. However, as shown in FIGS. 7 and 8, as we move from the middle part to the lower part of the joint, the metallographic structure of the SS 400 material comprises perlite, which is softer and appears black, and ferrite, which appears white.

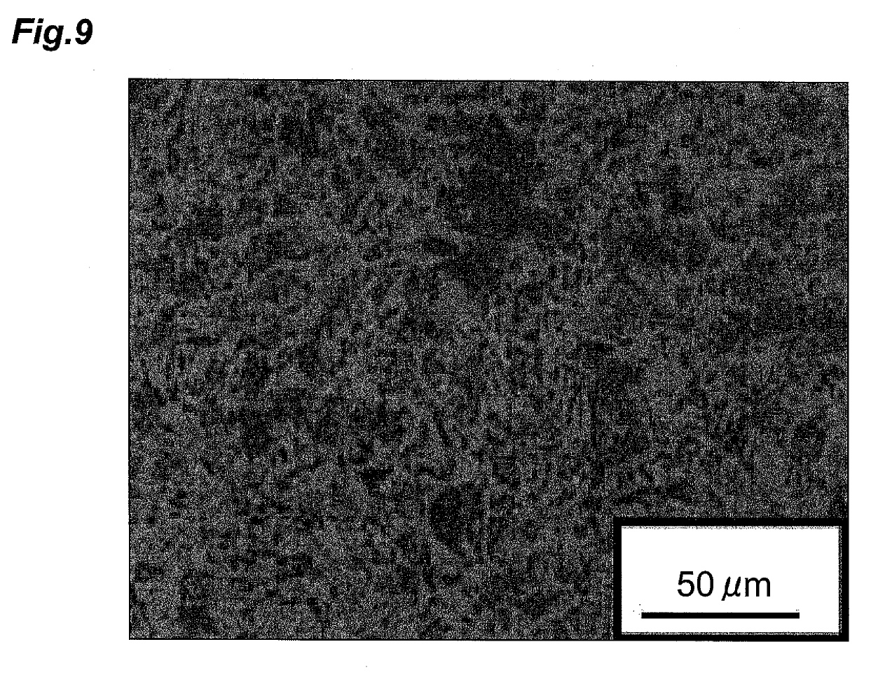

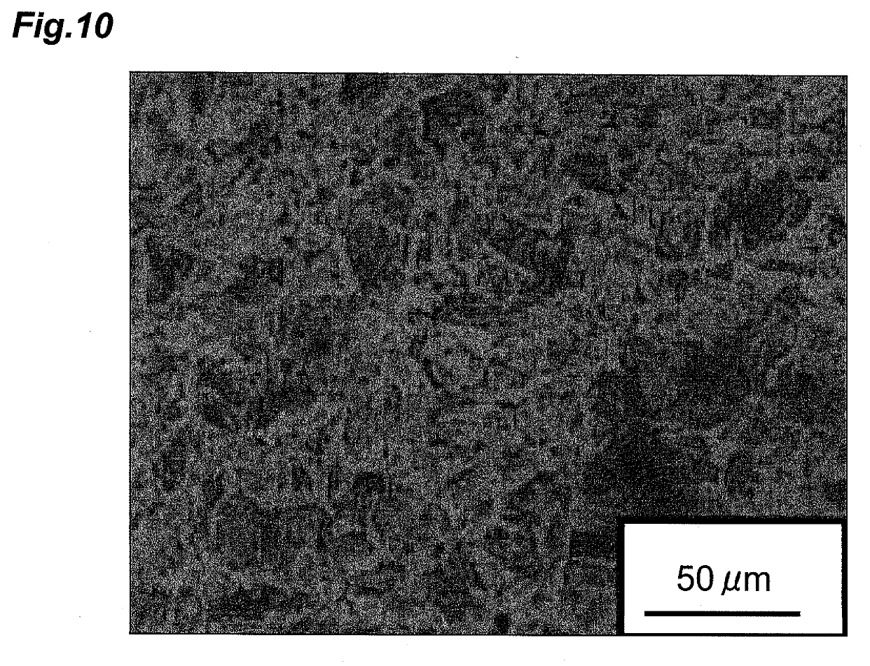

Meanwhile, FIGS. 9 to 11 show the metallographic structure of the metal materials at the upper part, middle part, and lower part, respectively, of the joint when friction stir welding was performed while liquid CO₂ was supplied. As shown in FIGS. 9 to 11, when friction stir welding was performed while liquid CO₂ was supplied, the metallographic structures of the SS 400 materials all comprised softer ferrite and harder martensite from the upper part to the lower part of the joint.

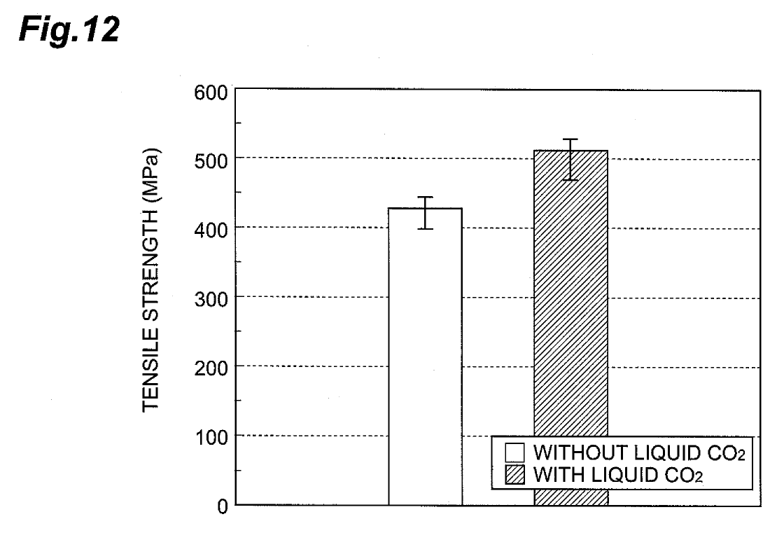

FIG. 12 is a graph of the tensile strength of the joint in the third test example of the present invention. As shown in FIG. 12, when friction stir welding was performed without supplying liquid CO₂, the tensile strength was 430 MPa. On the other hand, when friction stir welding was performed while liquid CO₂ was supplied, the tensile strength was high, at over 500 MPa. The reason for this believed to be that the metallographic structure of SS 400 is morphologically controlled to a structure composed of martensite, which is high in hardness, and ferrite, which is low in hardness but is sticky, at all sites from the upper part to the lower part of the joint, so the joint strength was increased.

The method of the present invention for joining metal materials is not limited to or by the above embodiments, and of course various modifications can be added without departing from the gist of the present invention.

1. A method for joining metal materials comprising: disposing two metal materials, at least one of which is a metal or an alloy thereof having a melting point of at least 1000° C., opposite each other at a joint;
inserting a rod-shaped rotary tool into the joint;
supplying a cooled coolant to either the joint or the rotary tool; and
rotating the rotary tool, whereby the two metal materials are joined.

2. The method for joining metal materials according to claim 1, wherein the two metal materials are joined by moving the rotary tool in a lengthwise direction of the joint while the rotary tool is rotated.

3. The method for joining metal materials according to claim 1, wherein the coolant is supplied in a state that includes a portion in either a solid phase or a liquid phase.

4. The method for joining metal materials according to claim 1, wherein the coolant is supplied after being cooled to a temperature of 0° C. or lower.

5. The method for joining metal materials according to claim 1, wherein the coolant is liquid CO₂.
